(19) United States
(12) Patent Application Publication
(10) Pub. No.: US 2002/0059857 A1
(43) Pub. Date: May 23, 2002

(54) Vinyl siding cutter

(76) Inventor: Garnett McKinley Eanes, Danville, VA (US)

Correspondence Address: Garnett M Eanes J.R., 2141 Inman Rd., Danville, VA, 24541, US

(21) Appl. No.: 09/935,328

(22) Filed: Aug. 23, 2001

Related U.S. Application Data
(60) Provisional application No. 60/229,466, filed on Sep. 1, 2000.

(51) Int. Cl. B26D 5/10; B26D 5/08

(52) U.S. Cl. 83/564; 83/523

(57) ABSTRACT

A vinyl siding cutter having blade guides suspended over base plate. A vinyl siding cutter that has a blade square on two corners; angled on other two corners to create a single point on cutting edge of blade.

### BACKGROUND OF INVENTION

As a typical practice of cutting vinyl siding in the field the use of hand snips or circular saws are common tools used.

Prior inventions designed simular are illustrated in. U.S. Pat. Nos. 4,510,834, 4,401,002, 3,362,070, 3,134,285, Des. 386,663. 5,010,795, 5,038,477, 5,249,495, & 5,251,524.

An important difference in this invention is the blade design and set up.

### SUMMARY OF INVENTION

This invention employs pointed designed blade fastened to a handle. The handle is fastened to a Pivot point. The blade travels between the guide to a base plate where it makes it's cut.

### BRIEF DESCRIPTION OF DRAWINGS

FIG. 1) is a view of the base plate shear plate and support legs. This view is provided to show a clear view of what is under the blade guides. Also shows details of shearing plate.

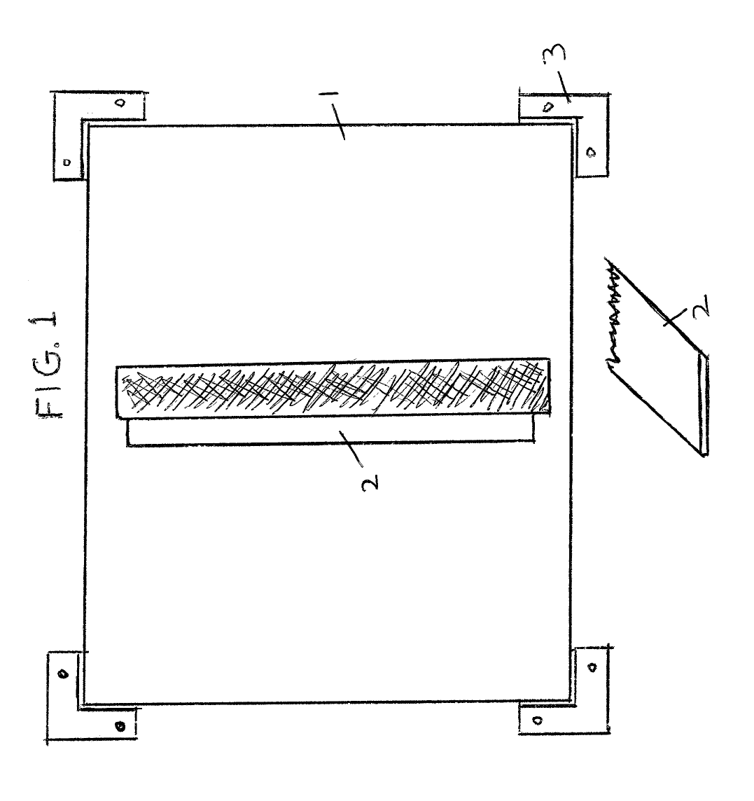

FIG. 2) is a view simular to FIG. 1 except the guides, blade, and remaining parts have been drawn in.

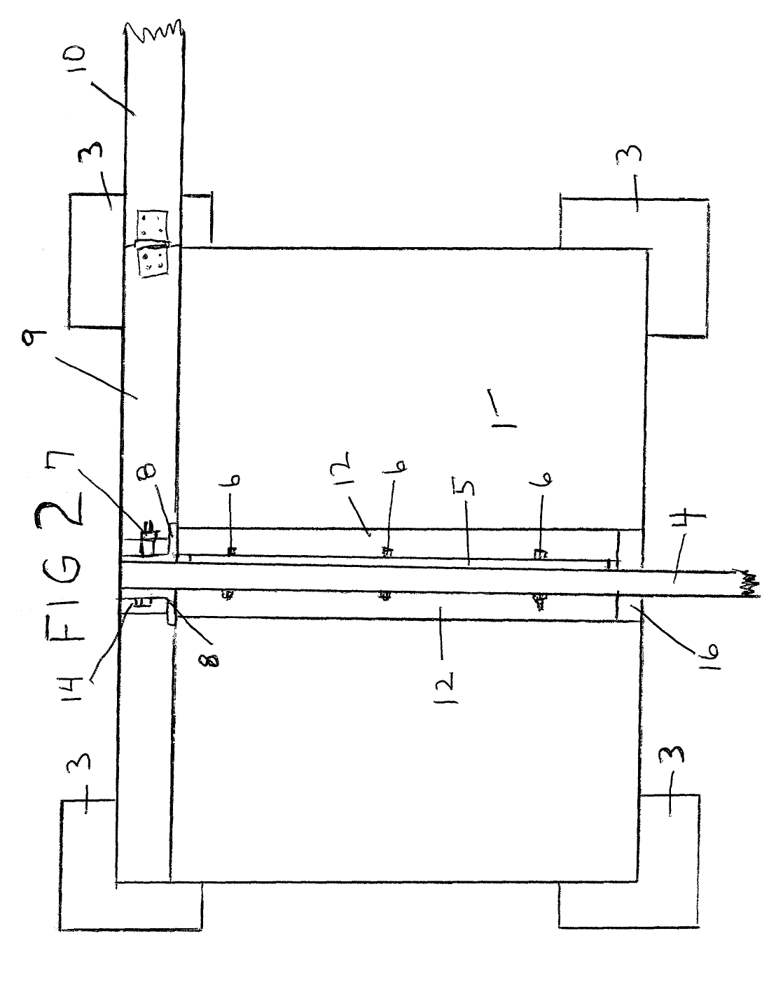

FIG. 3) is a side view illustrating the cutter construction & various parts. A Top veiw detail of the attachment of the blade to the pivot point is shown.

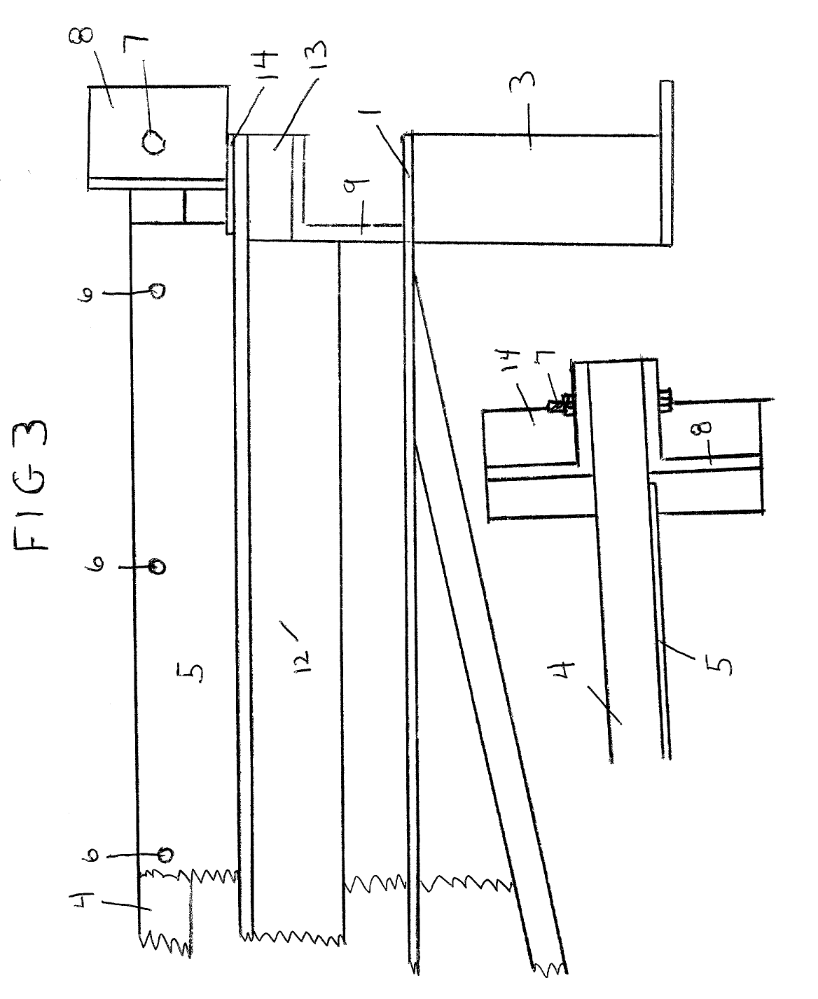

FIG. 4) is a drawing meant to illustrate the cutter in operation. It shows a piece of vinyl siding in the cutter. It also is an effort to demonstate the actual function of the cutter.

FIG. 5) is a view or the blade & handle side & end views.

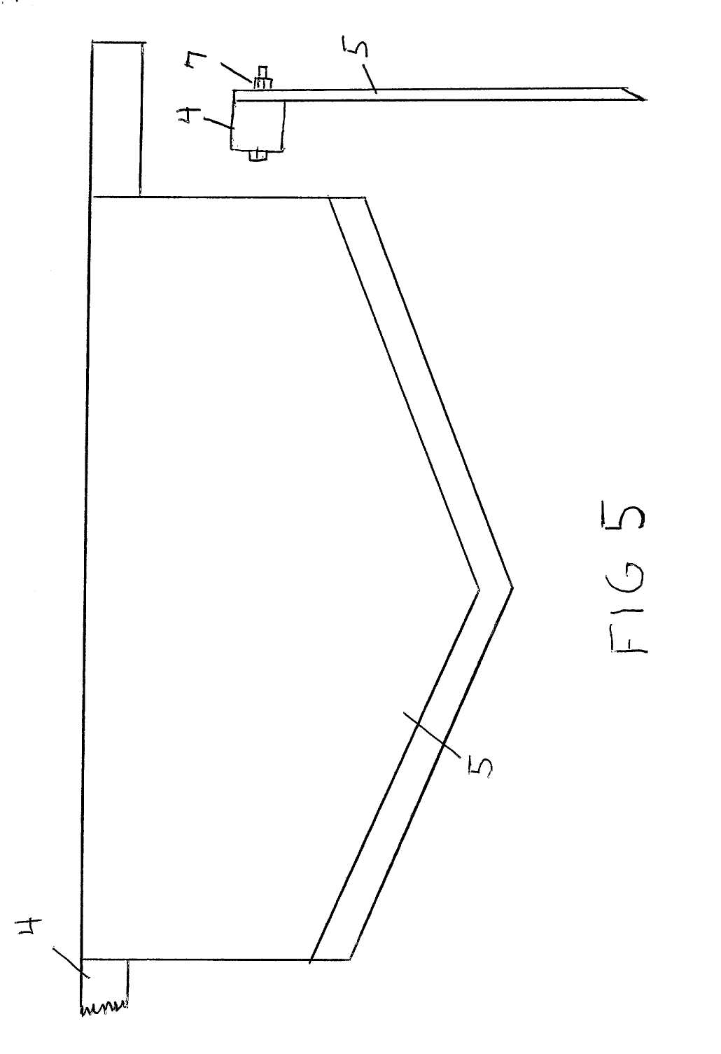

### DESCRIPTION OF A PREFERRED EMBODIMENT

The drawings provided illustrate a vinyl siding cutting tool with base plate 5 fastened to a handle.4 The handle 4 pivots in the two fastening brackets 8 The handle 4 pivots in a vertical motion only. In a downward vertical pivot of handle 4 the blade 5 passes between the blade guides 12. After passing between the guides 12 the blade 5 then rubs against the shear plate 2.

The blade handle 4 is held to the fastening brackets 8 by a blot 7.

The blade 5 is held to handle by three bolts 6.

The fastening bracket 8 are fastened to the top of the cutting fence 9. The cutting fence 9 & 10 is a two piece unit hinged 11 together. The fence 9 is fastened to the base plate 1.

The base plate 1 is mounted on for legs 3. The leg keeps the blade 1 from coming in contact with what ever the cutter is setting on.

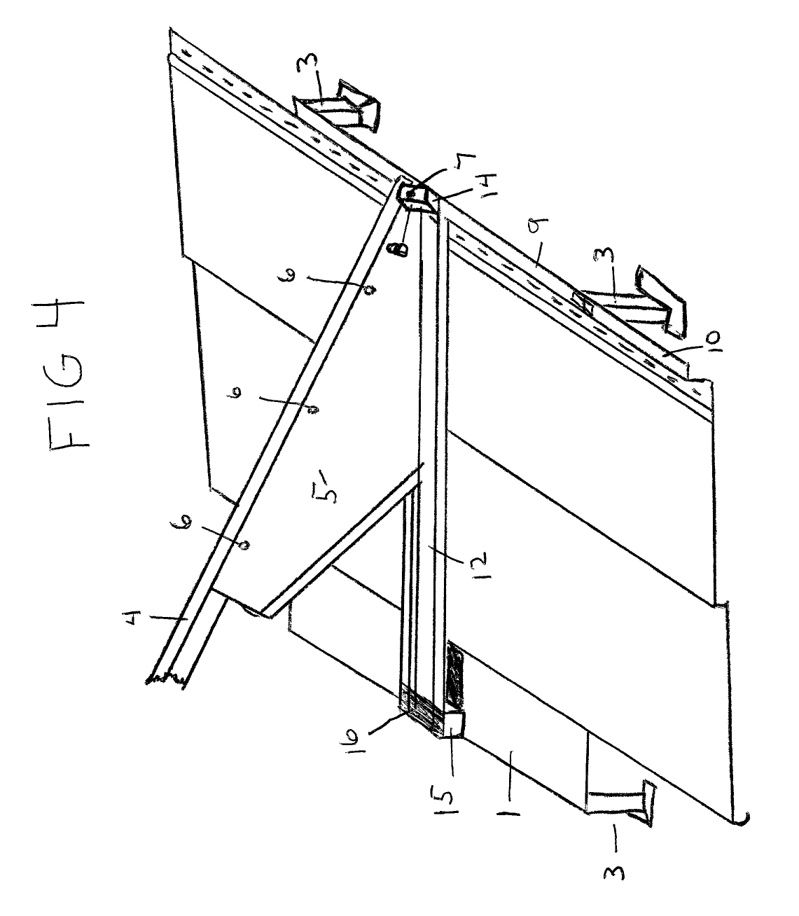

The blade guides 12 are fastened to two pieces of angle 15 & 13. Which are fastened to base plate 1 on 15 and fence on 13. The two guides 12 are held together by 14 & 16. The blade guides 12 are evelvated above the base plate 1 to allow the siding material A FIG. 4 to pass between.

I claim in reference to provisional No. 60/229,466 Filed on Sep. 01, 2000.

1) A vinyl siding cutter with a pointed blade design. As shown in illustrations presented.

2) A blade guide systems which guides blade between two guides positioned in the center of base given support on both side of blade. The two blade guides are for guiding blade and involved in actual cutting for guiding blade and not involved in actual cutting.

3) A fence installed on base of cutter separated by hinge for easy transpprt.

What is claimed:

1. A vinyl siding cutter having blade guides supporting both sides of blade suspended over base plate in alignment with shear plate on cutting side of blade.

2. A base plate with a slot that has a adjustable shear plate on cutting edge of slot.

3. A vinyl siding cutter having a blade thats square on two corners, angled on other two corners to create a single point on cutting edge of blade.
